(19) United States
(12) Patent Application Publication
(10) Pub. No.: US 2009/0027332 A1
(43) Pub. Date: Jan. 29, 2009

(54) MOTOR VEHICLE COCKPIT

(75) Inventors: Stephan CIELER, Frankfurt (DE); Guido Meier-Arendt, Langen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/181,174

(22) Filed: Jul. 28, 2008

(30) Foreign Application Priority Data
Jul. 27, 2007 (DE) 10 2007 035 769.0

(51) Int. Cl. G09G 5/00

(52) U.S. Cl. 345/156; 345/1.1

(57) ABSTRACT

A motor vehicle cockpit display system includes display units for displaying information arranged at different positions in a passenger compartment of the motor vehicle. A control arrangement controls the content of the information which is respectively displayed on the display units. A recording device senses in a contactless fashion an assignment of a user's limb to a first display unit and a gesture-dependent change in the assignment to a further display unit. Information relating to the change in the assignment is fed to the control arrangement, and the further display unit can be actuated to display the information of the first display unit by the control arrangement in accordance with the change in the assignment.

### BACKGROUND OF THE INVENTION

1. Field of the Invention

The invention relates to a motor vehicle cockpit having a number of display units for displaying information, the display units being arranged at different positions in the passenger compartment of the motor vehicle, and a control arrangement that controls the category and content of the information respectively displayed on the display units.

2. Description of the Related Art

In motor vehicle cockpits having plural display units it is known to control the category and the content of the information which is respectively displayed on a display unit by manipulation of a rotary pushbutton switch.

However, operating the rotary pushbutton switch involves, to a certain extent, distraction of the driver from the events on the road and can therefore cause accidents.

### SUMMARY OF THE INVENTION

An object of the present invention is to provide a motor vehicle cockpit having a plurality of display units and a control arrangement that controls the category and content of information respectively displayed on the display units in which the display of information of a display unit may be switched to another display unit in a way which is particularly free of distraction and easy to handle.

The object is achieved by an embodiment of the present invention including a recording device that can sense in a contactless fashion an assignment of a user's limb and/or of an object arranged on the limb to a first display unit and a gesture-dependent change in the assignment to a further display unit. The information relating to the change in the assignment sensed by the recording device is transmitted or fed to the control arrangement, and the further display unit is actuated by the control arrangement to display the information of the first display unit in accordance with the change in the assignment.

The present invention thus makes possible switching over of the display of information of one display unit to another display unit without the user having to divert his attention from the events in the road and without having to feel for a rotary pushbutton switch with his hand and operate it.

For the most part, the switching over operation is accomplished with no distraction from the events on the road.

In addition, the operation is simple and very easy to learn.

The information displayed can therefore be assigned to the individual display devices according to the personal requirements of the user without a large degree of expenditure.

The object arranged on the user's limb may, for example, be an armband or a ring which can be sensed particularly well by the recording device.

The assignment of the user's limb and/or the object arranged on the limb can easily be effected by aiming the limb and/or the object arranged on the limb at the display unit.

In this context, the gesture-dependent change in the assignment can be effected by a movement of the limb and/or the object arranged on the limb from a position in which it is aimed at the first display unit into a position in which it is aimed at the further display unit.

In one embodiment, the user's hands and/or arms are used for indicating the assignment and the gesture-dependent change in the assignment. This particular embodiment requires no additional objects.

To sense the assignment and the change in the assignment of the user's limb visually and to evaluate it, the recording device may be a video camera, and the control arrangement may have an image processing unit.

On the basis of the evaluation of the change in the assignment, actuation is then effected to switch the display.

To signal to the user that his instruction has been sensed, a confirmation signal is issued confirming the assignment of the user's limb and/or the object arranged on the limb to the display unit according to an embodiment of the present invention.

In this context, the confirmation signal may be displayed visually on the display unit and/or indicated acoustically.

The display units may include a combination instrument which is arranged at the front side in front of the driver's seat, a display in the central region of a dashboard, a display in a center console, and/or a head-up display.

According to a further embodiment, the display units are assigned display priorities of a different degree, and the information which can be displayed is correspondingly assigned information priorities of a different degree, wherein a display unit can only display information whose degree of priority is the same as or higher than the degree of the display priority of this display unit. This embodiment avoids the display of low-priority, distracting information in the direct field of vision.

In this context, the information which can be displayed includes entertainment information such as, for example, a radio transmitter indication or MP3 title indication, on-board computer information such as, for example, range or average fuel consumption, and/or navigation information such as an arrow symbol or distance from the next turning point or road on which the vehicle is currently traveling.

The control arrangement can be deactivated when the motor vehicle and/or the drive engine of the motor vehicle is in a stationary state.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a front view of a motor vehicle cockpit according to an embodiment of the present invention;

FIG. 2 shows the motor vehicle cockpit of FIG. 1 in which a user's hand is assigned to one of the displays;

FIG. 3 shows the motor vehicle cockpit of FIG. 1 in which the assignment is indicated;

FIG. 4 shows the motor vehicle cockpit of FIG. 1 in which the user's hand indicates a change in assignment;

FIG. 5 shows the motor vehicle cockpit of FIG. 1 in which the user's hand indicates a different change in assignment;

FIG. 6 shows the motor vehicle cockpit of FIG. 1 with all the possible display units indicated; and

FIG. 7 is a schematic block diagram showing the connection of the display units of the motor vehicle cockpit of FIG. 1 to a control arrangement.

### DETAILED DESCRIPTION OF THE PRESENTLY PREFERRED EMBODIMENTS

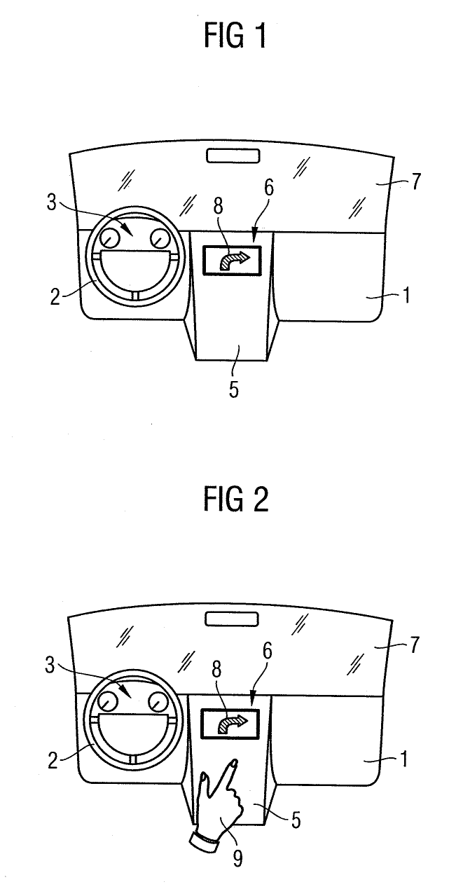

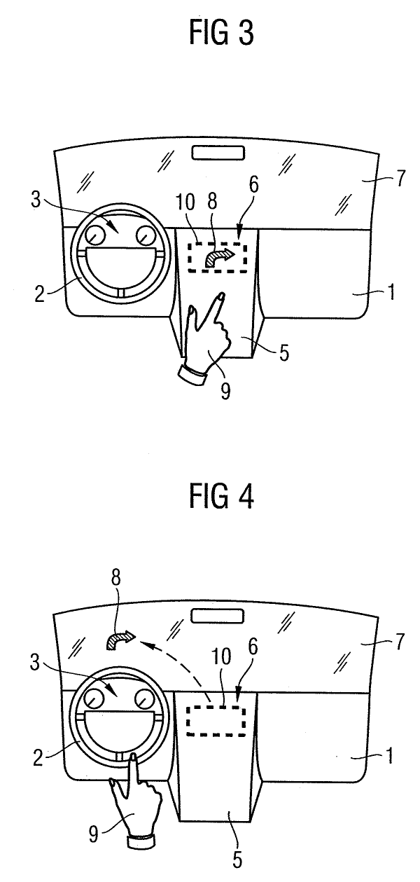

The motor vehicle cockpit illustrated in FIG. 1 has a dashboard 1 in front of which a steering wheel 2 is arranged. A combination instrument 3 having a first display 4 is arranged on the dashboard 1 in the region of the steering wheel 2. A center console 5 which includes a second display 6 is arranged next to the position of a driver which is indicated by the steering wheel 2. A windshield 7 is located above the dashboard 1. Visual maneuvering information of a navigation system illustrated as an arrow 8 which bends away to the right is illustrated in FIG. 1 on the second display 6, in the region of the center console 5.

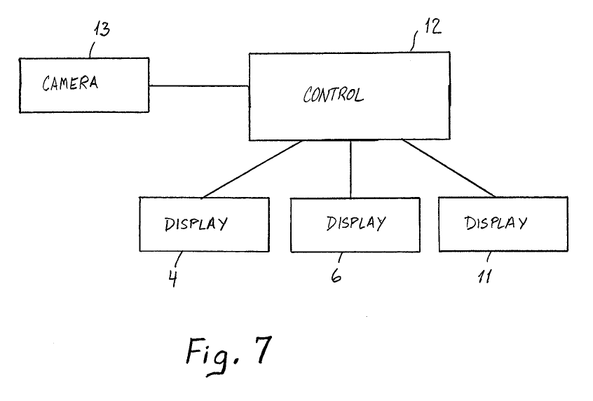

In FIG. 2, the driver is shown as user with his right hand 9 in the area of the second display 6. Through a display of a dotted border 10 on the second display 6, the assignment of the hand 9 to the second display 6 is indicated. This assignment is captured by a video camera 13 (see FIG. 7). A signal indicating the assignment is processed in an image processing unit in a control arrangement 12 (see FIG. 7) in order to actuate the border 10 as a confirmation signal.

A movement of the hand 9 from its orientation aimed at the second display 6 to an orientation aimed at the region of the windshield 7 in front of the driver's position is shown in FIG. 4 is also captured by the video camera 13 and processed by the image processing unit in the control arrangement 12. In response to the detected movement of the hand 9, the control arrangement 12 changes over the previous display of the arrow 8 from the second display 6 to the display in the region of the windshield 7 by a head-up device 11 (see FIG. 7).

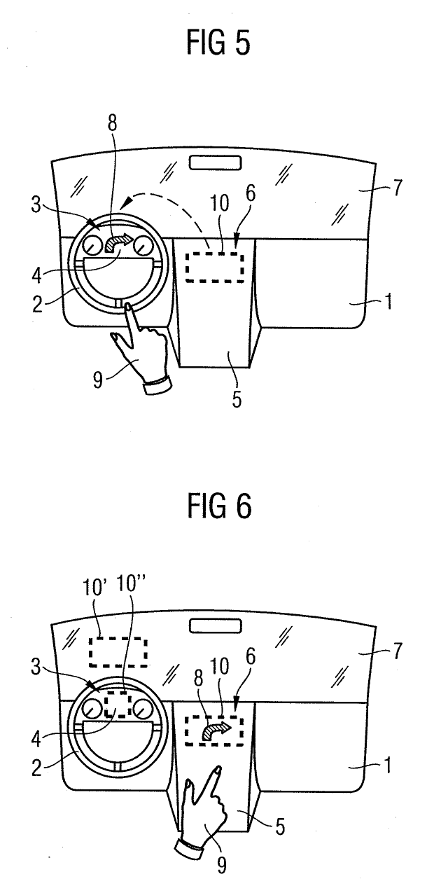

Alternatively, the user's hand 9 may be moved from its orientation aimed at the second display 6 to an orientation aimed at the first display 4 in the combination instrument 3 as shown in FIG. 5. This alternative movement can also be captured by the video camera 13 and correspondingly processed by the image processing unit in the control arrangement 12 so that the display of the arrow 8 on the second display 6 is moved from the second display 6 to the first display 4.

FIG. 6 illustrates that when the hand 9 is oriented or aimed at one of the display units—here the second display 6—a confirmation signal in the form of a border 10, 10′ and 10″ is also actuated on each of all the existing further display units, here the first display 4 and the head-up display in the region of the windshield 7. As a result, the driver is provided with an indication of all the display units to which he can switch over what is displayed on the second display 6.

FIG. 7 shows the interconnections between display units 4, 6, 11, control arrangement 12, and video camera 13.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A motor vehicle cockpit display system, comprising:
a plurality of display units for displaying information arranged at different positions in the motor vehicle cockpit;
a control arrangement configured to control the content to be displayed on each of said plurality of display units; and
a recording device configured to sense an assignment of a user's limb or an object arranged on the limb to a first display unit of said plurality of display units and to sense a gesture-dependent change in the assignment to a further display unit of said plurality of display units without contacting the user's limb or an object arranged on the limb, said recording device being configured to transmit information relating to the change in the assignment to said control arrangement, and said control arrangement being configured to actuate said further display unit to display the display information of said first display unit in accordance with the change in the assignment.

2. The motor vehicle cockpit of claim 1, wherein the assignment of the user's limb or the object arranged on the limb is effected by aiming the limb or the object arranged on the limb at said first display unit.

3. The motor vehicle cockpit of claim 2, wherein the gesture-dependent change in the assignment is effected by a movement of the limb or the object arranged on the limb from a first position aimed at said first display unit into a second position aimed at said further display unit.

4. The motor vehicle cockpit of claim 1, wherein the user's limb is one of the user's hands or arms.

5. The motor vehicle cockpit of claim 1, wherein said recording device is a video camera, and said control arrangement includes an image processing unit.

6. The motor vehicle cockpit of claim 1, wherein the control arrangement is configured to provide a confirmation signal to confirm the assignment of the user's limb or the object arranged on the limb to said first display unit.

7. The motor vehicle cockpit of claim 6, wherein the confirmation signal is displayed visually on said first display unit or indicated acoustically.

8. The motor vehicle cockpit of claim 1, wherein said first display unit is one of a combination instrument arranged at a front side in front of the driver's seat, a display in the central region of a dashboard, a display in a center console, or a head-up display.

9. The motor vehicle cockpit of claim 1, wherein said display units are each assigned display priority of a different degree, and the information to be displayed is correspondingly assigned information priorities of a different degree, wherein each of said display units is configured to display information having an information priority having a degree that is the same as or higher than a degree of the display priority of said each of said display units.

10. The motor vehicle cockpit of claim 9, wherein the information to be displayed is entertainment information, on-board computer information, or navigation information.

11. The motor vehicle cockpit of claim 10, wherein the information to be displayed is a radio transmitter indication, MP3 title indication, range, average fuel consumption, an arrow symbol, or distance from the next turning point or road on which the vehicle is currently travelling.

12. The motor vehicle cockpit of claim 1, wherein said control arrangement is deactivated when the motor vehicle or a drive engine of the motor vehicle is in a stationary state.
